(19) United States
(12) Patent Application Publication
(10) Pub. No.: US 2004/0203845 A1
(43) Pub. Date: Oct. 14, 2004

(54) Method and system for associating location specific data with data in a mobile database

(76) Inventor: Amrish K. Lal, San Jose, CA (US)

Correspondence Address: SAWYER LAW GROUP, P.O. Box 51418, Palo Alto, CA, 94303, US

(21) Appl. No.: 10/104,538

(22) Filed: Mar. 22, 2002

(51) Int. Cl. H04Q 7/20

(52) U.S. Cl. 455/456.1; 455/557; 455/412.1

(57) ABSTRACT

A method and system for associating location specific data with data in a database is disclosed. According to the method and system of the present invention, the system includes a database management system coupled to the database, a memory value in the database management system for obtaining location specific data, and a datatype for the memory value for storing the location specific data. In a preferred embodiment, location specific data is obtained from a navigation system coupled to the database management system. In another preferred embodiment, the method and system of the present invention further includes a plurality of functions for performing database calculations based on the stored location specific data.

Through aspects of the method and system of the present invention, a built-in mechanism for automatically capturing where an event took place is made available in a database system utilized in a mobile device. By providing a location specific memory value and datatype in the DBMS, there is no need to customize application programs in the mobile devices in order to associate location specific data with data in the database. Using built-in functions defined by the method and system of the present invention, the user can carry out calculations based on the location of the events or on their position relative to a fixed point.

### FIELD OF INVENTION

The present invention relates generally to database management systems, and more particularly to a method and system for automatically associating location specific data with data in a mobile database in a mobile device.

### BACKGROUND OF THE INVENTION

The need to increase business productivity is creating widespread opportunities for vendors and manufacturers who can leverage mobile devices to connect employees with their companies' enterprise applications and data. With handheld devices, employees can gather and update data where and when it changes. They can also perform realtime queries and transmit information directly into their companies' enterprise business systems in the course of doing business. Appliances and machines are also becoming more intelligent and valuable die to their ability to gather and work with realtime data in a variety of situations.

In order to operate in this efficient way, handheld and embedded devices require robust, stable database engines with small footprints. They also need to connect with enterprise data sources, and support the widest possible range of platforms and application development tools. Small footprint relational databases, such as DB2 Everyplace® developed by International Business Machines Corporation, Armonk, N.Y., have been developed to fulfill these requirements. For instance, DB2 Everyplace is a small-footprint relational database (approximately 150 KB) that runs on various operation systems such as, Palm OS, EPOC, WinCE, QNX Neutrino, and Embedded Linux, to name a few. It is designed to work on platforms that have limited memory and restricted storage capacity. The code base is designed for easily porting to various operating systems and architectures of mobile and embedded devices. The SQL syntax support by DB2 Everyplace consists only of the most commonly used SQL constructs, and are sufficient for most applications targeted to be run on these devices.

Conventional database systems, that is, database systems installed and utilized on stationary systems, such as a workstation or server, have the ability automatically to record time specific data through defined memory values, such as CURRENT DATE, CURRENT TIME and CURRENT TIMESTAMP. These memory values have corresponding datatypes defined by the database system. Values for these memory values are obtained from a system clock during program execution. Thus, the database system can associate a date and time with data stored in the database.

Unlike traditional database systems, the small footprint database system, e.g., DB2 Everyplace, is designed for use in mobile or thin devices, and is, therefore, inherently mobile. This added dimension presents a new variable to the data stored on these devices; specifically, the data can be location specific, as well as date and time specific. No mechanism currently exists that allows a mobile device to automatically associate geographic location with data stored in the mobile database system. In turn, data analysis based on geographic location is also not possible. If a user wishes to record and manipulate data based on such information, the user must customize the application programs in the device to deal with location. This is not only time consuming, but also requires additional code to be added to the application programs, which consumes already limited memory resources.

Accordingly, what is needed is a method and system for associating geographic location information with data stored in a mobile database. The method and system should be automatic, and should not tax the limited resources of the mobile device. The present invention addresses such a need.

### SUMMARY OF THE INVENTION

The present invention is directed to a method and system for automatically associating location specific data with data in a database. According to the method and system of the present invention, the system includes a database management system coupled to the database, a memory value in the database management system for obtaining location specific data, and a datatype for the memory value for storing the location specific data. In a preferred embodiment, location specific data is obtained from a navigation system coupled to the database management system. In another preferred embodiment, the method and system of the present invention further includes a plurality of functions for performing database calculations based on the stored location specific data.

Through aspects of the method and system of the present invention, a built-in mechanism for automatically capturing where an event took place is made available in a database system utilized in a mobile device. By providing a location specific memory value and datatype in the DBMS, there is no need to customize application programs in the mobile devices in order to associate location specific data with data in the database. Using built-in functions defined by the method and system of the present invention, the user can carry out calculations based on the location of the events or on their position relative to a fixed point.

### BRIEF DESCRIPTION OF THE DRAWINGS

FIG. 1 illustrates a block diagram of a mobile device that utilizes the mobile database management system according to a preferred embodiment of the present invention.

FIG. 2 illustrates a process for associating location specific data with data in the database according to a preferred embodiment of the present invention.

### DETAILED DESCRIPTION OF THE INVENTION

The present invention is directed to a method and system for automatically associating location specific data with data in a mobile database in a mobile device. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiments shown but is to be accorded the widest scope consistent with the principles and features described herein.

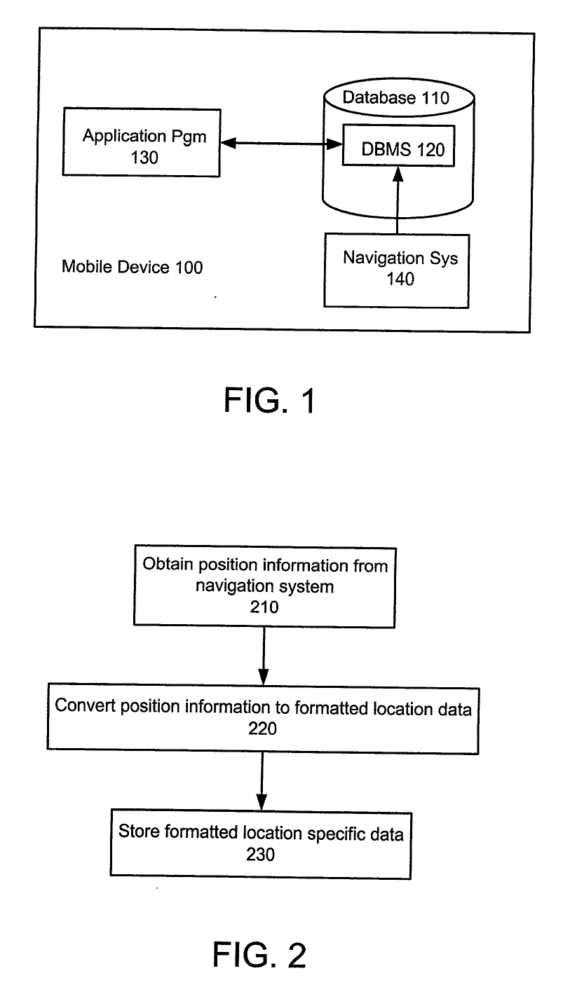

FIG. 1 illustrates a block diagram of a mobile device 100 that utilizes the mobile database management system 120 according to a preferred embodiment of the present invention. The mobile device 100 can be any mobile device that possesses data processing capability, such as a personal digital assistant (PDA), a laptop computer, or a cellular phone. As is shown in FIG. 1, the mobile device 100 includes a database 110 that is managed by a database management system (“DBMS”) 120, such as DB2 Everyplace. Application programs 130 access the data in the database 110 via the DBMS 120.

The DBMS 120 is coupled to a navigation system 140. The navigation system 140 is any system that can ascertain location specific information, such as a Global Positioning System (“GPS”). The GPS uses a worldwide radio-navigation system formed from a constellation of 24 satellites and their ground stations. A receiver in the GPS uses the satellites as reference points to calculate the position of the receiver. The navigation system 140 can either be embedded within the mobile device 100, or it can be a plug-in component coupled to the mobile device 100.

The method and system in accordance with the present invention defines in the mobile DBMS 120, a new memory value variable, CURRENT LOCATION, and a new built-in datatype, LOCATION, to associate location specific data with data stored in the database 110. FIG. 2 illustrates a process 200 for associating location specific data with data in the database 110 according to a preferred embodiment of the present invention. In step 210, the CURRENT LOCATION memory value is used to obtain positioning information from the navigation system 140. In step 220, the positioning information is converted into a format specified by the LOCATION datatype. In a preferred embodiment, the LOCATION datatype format is in latitudinal and longitudinal coordinates. Nevertheless, those skilled in the art would readily appreciate that other means of identifying a global position are available, such as a Cartesian (x, y, z) coordinate system. The formatted location specific information is then stored in step 230.

The method and system of the present invention also defines built-in functions that enable a user to carry out calculations based on the location specific data. Such built-in functions include relational operators, such as=, >, <, <>, >= and =<, that allow the user to access data based on the location specific data relative to a specified location. In addition, location descriptors, such as LEFT, RIGHT, ABOVE, BELOW, also provide flexibility for the user to perform location based calculations.

Following, are example SQL statements utilizing the CURRENT LOCATION memory value and LOCATION datatype.

### EXAMPLE 1

### Create Table to Store Location and Time Specific Data

CREATE TABLE event (when TIMESTAMP, loc LOCATION, what VARCHAR(100));

INSERT INTO event (CURRENT TIMESTAMP, CURRENT LOCATION, ‘bumped into Steve, exchanged notes on XYZ sales’);

INSERT INTO event (CURRENT TIMESTAMP, CURRENT LOCATION, ‘weather is good here during this time of the year’);

INSERT INTO event (CURRENT TIMESTAMP, CURRENT LOCATION, ‘flash flood warning in progress’)

### EXAMPLE 2

### Find All Events That Occurred Here

SELECT what FROM event WHERE loc=CURRENT LOCATION

### EXAMPLE 3

### Find All Events That Occurred At A Particular Location

SELECT*FROM event WHERE loc={latitude, longitude}

Through aspects of the method and system of the present invention, a built-in mechanism for automatically capturing where an event took place is made available in a mobile database system. By defining the new memory value variable, CURRENT LOCATION, and built-in datatype, LOCATION, in the DBMS, there is no need to customize application programs in the mobile devices in order to associate location specific data with data in the database. Using built-in functions defined by the method and system of the present invention, the user can carry out calculations based on the location of the events or on their position relative to a fixed point.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for associating location specific data with data in a database comprising the steps of:
(a) providing a memory value in a database management system coupled to the database for obtaining location specific data; and
(b) providing a datatype for the memory value for storing the location specific data.

2. The method of claim 1 further comprising the step of:
(c) obtaining location specific data from a navigation system coupled to the database management system.

3. The method of claim 2 further comprising the step of:
(d) converting the location specific data obtained from the navigation system to a format specified by the datatype for the memory value.

4. The method of claim 2, wherein the database is utilized within a handheld portable mobile device and the navigation system is an embedded component in the mobile device.

5. The method of claim 4, wherein the navigation system is a plug-in component.

6. The method of claim 1, wherein the datatype providing step (b) further includes the step of:
(b 1) defining the datatype in latitudinal and longitudinal coordinates.

7. The method of claim 1, wherein the datatype providing step (b) further includes the step of:
(b1) defining the datatype in Cartesian coordinates.

8. The method of claim 1 further comprising the step of:
(c) providing a plurality of functions for performing database calculations based on the stored location specific data, wherein the plurality if functions includes relational operators and location descriptors.

9. A computer readable medium containing programming instructions for associating location specific data with data in a database comprising the programming instructions for:
(a) providing a memory value in a database management system coupled to the database for obtaining location specific data; and
(b) providing a datatype for the memory value for storing the location specific data.

10. The computer readable medium of claim 9 further comprising the instruction for:
(c) obtaining location specific data from a navigation system coupled to the database management system.

11. The computer readable medium of claim 10 further comprising the instruction for:
(d) converting the location specific data obtained from the navigation system to a format specified by the datatype for the memory value.

12. The computer readable medium of claim 10, wherein the database is utilized within a handheld portable mobile device and the navigation system is an embedded component in the mobile device.

13. The computer readable medium of claim 12, wherein the navigation system is a plug-in component.

14. The computer readable medium of claim 9, wherein the datatype providing instruction (b) further includes the instruction for:
(b1) defining the datatype in latitudinal and longitudinal coordinates.

15. The computer readable medium of claim 9, wherein the datatype providing instruction (b) further includes the instruction for:
(b1) defining the datatype in Cartesian coordinates.

16. The computer readable medium of claim 9 further comprising the instruction for:
(c) providing a plurality of functions for performing database calculations based on the stored location specific data, wherein the plurality if functions includes relational operators and location descriptors.

17. A system for associating location specific data with data in a database, comprising:
a database management system coupled to the database;
a memory value in the database management system for obtaining location specific data; and
a datatype for the memory value for storing the location specific data.

18. The system of claim 17 further comprising:
a navigation system coupled to the database management system.

19. The system of claim 18 further comprising a converter for converting the location specific data to a format specified by the datatype for the memory value.

20. The system of claim 18, wherein the database is utilized within a handheld portable mobile device.

21. The system of claim 20, wherein the navigation system is an embedded component in the mobile device.

22. The system of claim 20, wherein the navigation system is a plug-in component.

23. The system of claim 18, wherein the navigation system is a Global Positioning System.

24. The system of claim 17, wherein the datatype for the memory value is latitudinal and longitudinal coordinates.

25. The system of claim 17, wherein the datatype for the memory value is Cartesian coordinates.

26. The system of claim 17 further comprising:
a plurality of functions for performing database calculations based on the stored location specific data.

27. The system of claim 26, wherein the plurality if functions includes relational operators and location descriptors.

28. A database management system coupled to a database in a mobile device comprising:
a navigation system coupled to the database management system;
a memory value in the database management system for automatically receiving
a datatype for the memory value for storing the location specific data in a specific format; and
a converter for converting the location specific data to the format specified by the datatype for the memory value.

29. The system of claim 28, wherein the mobile device is a portable handheld device.

30. A system of claim 29, wherein the navigation system is embedded in the portable handheld mobile device.

31. A method for associating location specific data with data in a database, wherein the database is utilized in a mobile handheld device, the method comprising the steps of:
(a) providing a memory value in a database management system coupled to the database for obtaining location specific data;
(b) providing a datatype for the memory value for storing the location specific data;
(c) receiving automatically location specific data from a navigation system coupled to the database management system;
(d) converting the location specific data received from the navigation system to a format specified by the datatype for the memory value; and
(e) providing a plurality of functions for performing database calculations based on the stored location specific data, wherein the plurality if functions includes relational operators and location descriptors.
